(19) United States
(12) Patent Application Publication
(10) Pub. No.: US 2005/0094421 A1
(43) Pub. Date: May 5, 2005

(54) Integrated charge pump voltage converter

(75) Inventors: Alberto Flore, Padova (IT); Markus Mullauer, Friesach (AT)

Correspondence Address: Andreas Grubert;Baker Botts L.L.P., One Shell Plaza, 910 Louisiana, Houston, TX, 77002-4995, US

(73) Assignee: Infineon Technologies AG

(21) Appl. No.: 10/977,182

(22) Filed: Oct. 29, 2004

(30) Foreign Application Priority Data
Oct. 31, 2003 (DE) 103 51 050.8

(51) Int. Cl. H02M 3/18

(52) U.S. Cl. 363/60

(57) ABSTRACT

An integrated charge pump voltage converter has an oscillator (1) for generating a switching frequency having at least one capacitance whose value governs the switching frequency generated. It also comprises a charge transfer capacitance (TC). A switching stage (S1, S1′, S2, S2′) controls the charging and discharging operations of the charge transfer capacitance (TC) on the basis of the switching frequency. In this arrangement, the charge transfer capacitance (TC) and the capacitance in the oscillator (1) are of the same type.

### PRIORITY

This application claims priority to German application no. 103 51 050.8 filed Oct. 31, 2003.

### TECHNICAL FIELD OF THE INVENTION

The present invention relates to a charge pump voltage converter produced using integrated circuitry.

### BACKGROUND OF THE INVENTION

In many battery-operated appliances, such as mobile telephones or PDAs (personal digital assistant), but also in applications which are not battery-supported, such as memory chips for PCs (personal computer), there is the need to have a voltage available which is higher than the system voltage (e.g. battery voltage). Various techniques are known which can be used to produce a voltage which is higher than the system voltage from a voltage which is available in the system (lower than or the same as the system voltage) without the need for an additional voltage source (e.g. an additional battery) in order to do so. Besides the widely employed DC-DC switches, which use a switched inductance as energy store, voltage converters of the charge pump type are known which use a switched capacitor—the “charge transfer capacitor”—as energy store. The charge transfer capacitor is charged via an input on the voltage converter and is discharged via the output of the voltage converter. In this arrangement, the charged charge transfer capacitor is connected in series with the input voltage upstream of the discharging operation so that (in theory) the input voltage is doubled at the output. The switching operations are performed using an oscillator which is connected to the switches.

A charge pump voltage converter having a switch panel comprising four MOS transistors is known from the specification U.S. Pat. No. 5,874,850.

Charge pump voltage converters may be produced in a hybrid design or in the form of integrated circuits. Since the output voltage of charge pump voltage converters is highly dependent on the switching frequency fₛ and on the size of the charge transfer capacitance, fluctuations in these two parameters which are brought about both by component tolerances and by changes in temperature adversely affect the quality and stability of the voltage converter. Integrated charge transfer capacitances have a wide range of fluctuation in relation to their absolute value C. Consequently, the dynamic resistance 1/(fₛ·C) when a small value C arises may be higher than expected, as a result of which the output voltage falls in relation to a given output current. Consequently, the problem may arise that a circuit powered by the charge pump voltage converter no longer operates perfectly on account of too low an input voltage.

A second difficulty is that the output voltage of the charge pump voltage converter is highly dependent on the switching frequency fₛ under load. If the oscillator frequency (which normally corresponds to the switching frequency fₛ) is significantly temperature-dependent—which is the case for ring oscillators for example —then this results in a pronounced temperature dependency for the output voltage of the charge pump voltage converter. This may likewise result in impairment of function or in failure of the circuit powered by a charge pump voltage converter.

To overcome these problems in integrated charge pump converters, various approaches are known. A first option is to choose the charge transfer capacitance to be large enough to guarantee that the output resistance of the charge pump voltage converter keeps to the desired output voltage value range even at the maximum production tolerance for the charge transfer capacitance and with the maximum change in temperature. The drawback of this practice is that large charge transfer capacitances need to be used, which means that the space requirement of the charge pump voltage converter on the chip rises (the majority of the chip surface of an integrated charge pump is required for the charge transfer capacitance). Consequently, the size and costs of the integrated circuit increase.

A second option is to adjust the switching frequency of the oscillator after it has been manufactured. This can be done, by way of example, by virtue of laser vaporization of suitable wiring (“fuses”) in the oscillator. A drawback of this practice is that a relatively large chip surface is required and the test time is lengthened.

A third option for overcoming the difficulties cited is to use a crystal oscillator to generate the switching frequency in the charge pump. The temperature-stable and precisely known switching frequency achieved in this manner means that a relatively large amount of play is left for the design of the charge transfer capacitance —the latter can be chosen to be smaller. What are disadvantageous are the increased costs on account of the use of a crystal oscillator.

### SUMMARY OF THE INVENTION

The invention is based on the object of providing an integrated charge pump voltage converter which can be manufactured at reasonable cost and produces an output voltage which is sufficiently stable for practical requirements. In particular, fluctuations in the output voltage which are brought about as a result of manufacturing tolerances and/or changes in temperature need to be kept down.

The object on which the invention is based can be achieved by a charge pump voltage converter which is produced using integrated circuitry and comprises an oscillator for generating a switching frequency, having at least one capacitance whose value governs a switching frequency generated, a charge transfer capacitance which is charged via an input on the charge pump voltage converter and is discharged via an output on the charge pump voltage converter, and a switching stage which is operated at the switching frequency and controls the charging and discharging operations of the charge transfer capacitance, wherein the charge transfer capacitance and the at least one capacitance in the oscillator are of the same type.

The oscillator can be a ring oscillator comprising a cascade of inverters. The outputs of the inverters can be buffered by the at least one capacitances in the oscillator. The at least one capacitances can be larger than input capacitances in the inverters. The charge pump voltage converter may further comprise a circuit for producing an operating current for the oscillator, which circuit is designed such that the operating current increases as temperature rises, so as thereby to counteract a decrease in the oscillator frequency which occurs as temperature rises. The circuit may have a first transistor and a current mirror, arranged in parallel with the first transistor, for providing the operating current for the oscillator. The input path of the current mirror may contain a second transistor, whose ratio of channel width to channel length is greater than the ratio of channel width to channel length in the first transistor. The charge pump voltage converter may further comprise a circuit element which gives rise to an essentially constant voltage difference between the first and the second transistor. The circuit element can be a diode which is connected in series with the second transistor in the input path of the current mirror. A USB interface may have such a charge pump voltage converter for producing the bus operating voltage.

Accordingly, the charge pump voltage converter produced using integrated circuitry has an oscillator for generating a switching frequency, the oscillator containing at least one capacitance whose value governs the switching frequency generated. In addition, the charge pump voltage converter comprises, according to the usual design, a charge transfer capacitance which is charged via an input on the charge pump voltage converter and is discharged via an output on the charge pump voltage converter, and a switching stage which is operated at the switching frequency and controls the charging and discharging operations of the charge transfer capacitance.

A fundamental aspect of the invention is that the (integrated) charge transfer capacitance and the (integrated) capacitance in the oscillator are of the same type (e.g. most suitably poly-poly type or MIM (Metal Insulator Metal) type, possibly even MOS (Metal Oxide Semiconductor) type; and sub-types thereof). The effect which can be achieved by this is that the effects brought about by manufacturing tolerances (change in the oscillator frequency on account of manufacturing tolerances in the capacitance in the oscillator; change in the output voltage of the voltage converter as a result of manufacturing tolerances in the charge transfer capacitance) compensate for one another to a very large extent, which means that stabilization of the circuit with respect to manufacturing tolerances is achieved. This means that the use of a comparatively small charge transfer capacitance allows simple, inexpensive oscillator circuits without a quartz oscillator as the oscillator to be used.

Preferably, the oscillator is an (inexpensive) ring oscillator comprising a cascade of inverters. In principle, in a ring oscillator the gate capacitances of the input transistors in the inverters themselves may represent the oscillator's capacitance which influences the switching frequency. Preferably, however, the outputs of the inverters are buffered by capacitances which represent the oscillator's capacitances which influence the switching frequency. Since an increase in the size of these capacitances and of the charge transfer capacitance which is brought about by manufacturing fluctuations firstly results in the frequency of the switching frequency being lowered leading to a reduction in the output voltage under load, and secondly brings about an increase in the size of the output voltage as a result of the increase in the charge transfer capacitance, these two effects compensate for one another, which means that the output voltage is stabilized significantly with respect to component variations.

If the capacitances in the ring oscillator are larger than the input capacitances in the inverters, i.e. dominate the latter, the switching frequency generated by the ring oscillator is inversely proportional to the capacitance value of these capacitances. In this case, the dynamic output resistance of the charge pump voltage converter remains constant, even in the case of manufacturing tolerances with a wide range of variation.

Besides ring oscillators, there is the general possibility of also using other oscillator types, e.g. oscillators based on a Schmitt trigger circuit with a capacitance which influences the switching frequency.

As temperature rises, the frequency of the oscillator, particularly the ring oscillator, decreases. One particularly advantageous refinement of the invention is therefore characterized by a circuit for producing an operating current for the oscillator, which circuit is designed such that the operating current increases as temperature rises, so as thereby to counteract the decrease in the oscillator frequency which occurs as temperature rises. This stabilizes the charge pump voltage converter with respect to changes in temperature too.

One particularly advantageous embodiment of the circuit for producing the operating current for the oscillator is characterized in that the circuit has a first transistor and a current mirror, arranged in parallel with the first transistor, for providing the operating current for the oscillator. In this case, the input path of the current mirror preferably contains a second transistor, whose ratio of channel width to channel length is greater than the ratio of channel width to channel length in the first transistor. The effect achieved by this measure is that the two transistors have different temperature characteristics, which means that the desired temperature dependence of the operating current produced by the circuit is brought about.

A further advantageous measure involves the circuit containing a switching means which gives rise to an essentially constant voltage difference between the first and the second transistor. The effect achieved by this is that the circuit for producing the operating current for the oscillator is insensitive towards manufacturing tolerances which significantly influence the threshold voltage of the transistors.

A multiplicity of applications for the inventive charge pump voltage converter are conceivable. One suitable application is, by way of example, a USB (Universal Serial Bus) interface with an inventive, integrated charge pump voltage converter for producing the bus operating voltage (5 V) for the USB.

### BRIEF DESCRIPTION OF THE DRAWINGS

The invention is explained in more detail below using an exemplary embodiment with reference to the drawings, in which:

FIG. 1 shows a schematic illustration of an integrated charge pump voltage converter with an oscillator;

FIG. 2 shows a circuit diagram for a ring oscillator based on the invention;

FIG. 3 shows a schematic illustration of the circuit for producing the operating current for the ring oscillator and of the ring oscillator;

FIG. 4 shows a variant embodiment of a circuit portion in FIG. 3; and

FIG. 5 shows an example of application of the inventive charge pump voltage converter.

### DETAILED DESCRIPTION OF EMBODIMENTS

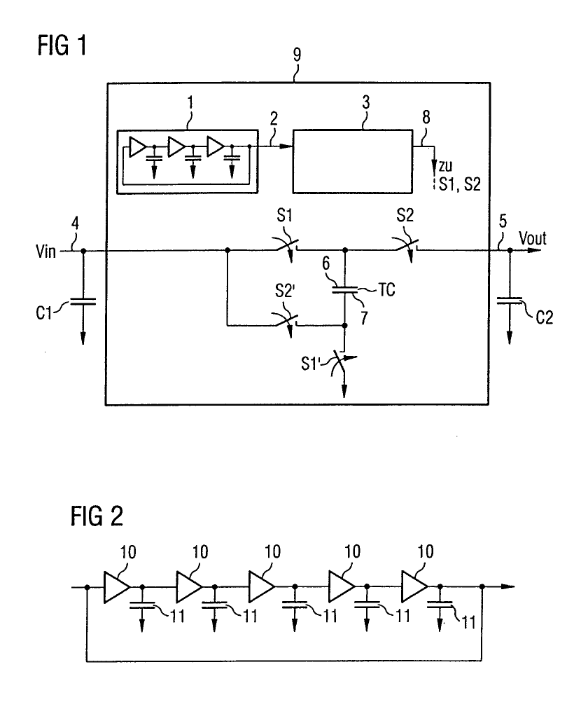

FIG. 1 shows an exemplary, simplified illustration of the design of an integrated charge pump voltage converter based on the invention. The voltage converter has an integrated oscillator 1 whose output 2 is connected to the input of a circuit for time control 3. The charge pump voltage converter also comprises a charge transfer capacitor TC which can be charged via an input 4 on the voltage converter and can be discharged via an output 5 on the voltage converter. For this, it is possible to connect a first electrode 6 on the charge transfer capacitor TC to the input 4 via a switch S1 and to the output 5 via a switch S2. The second electrode 7 of the charge transfer capacitance TC may likewise be connected to the input 4 of the voltage converter via a switch S2′. In addition, the second electrode 7 can be earthed via a switch S1′ and thereby discharged.

The input 4 of the voltage converter is optionally connected to earth via a capacitance C1. At the output 5, a capacitance C2 is connected to earth.

The switches (transistors) S1, S2, S1′, S2′ are controlled by the time control circuit 3 via an output 8. It will be pointed out that a multiplicity of different options in relation to the time control circuit and to the arrangement and design of the switches S1, S2, S1′, S2′ are known which can also be taken as a basis for implementing the inventive circuit.

The line 9 indicates that the oscillator 1, the control circuit 3, the switches S1, S2, S1′, S2′ and the charge transfer capacitance TC are integrated on one chip. The capacitances C1 and C2 may likewise be produced on the chip.

The known way in which a charge pump voltage converter works is described below to provide a better understanding of the invention:

In a first operating phase, the switches S1 and S1′ are on and the switches S2 and S2′ are off. In this phase, the charge transfer capacitance TC is being charged by the input voltage. When the charging operation is complete (or else earlier than this), the switches S1 and S1′ are turned off and the switches S2 and S2′ are turned on. This raises the second electrode 7 of the charge transfer capacitance TC to the potential of the input voltage. Consequently, a voltage which is given by the sum of the input voltage and of the charging voltage of the charge transfer capacitance TC—i.e. no more than twice the input voltage—appears at the output 5 of the voltage converter. The charge transfer capacitor TC is now discharged at the output. This cycle is performed in constant repetition.

The output voltage Vₒᵤₜ of the voltage converter is given by the following equation:

$${V}_{out} = {V}_{in} \cdot ( 1 + \frac{C}{C + {C}_{par}} ) - ( \frac{1}{{f}_{s} \cdot C} + 2 \cdot {R}_{SW} ) \cdot {I}_{out} . \qquad ( 1 )$$

In this case, Vᵢₙ denotes the input voltage of the voltage converter, C denotes the value of the charge transfer capacitance TC, Cₚₐᵣ denotes a parasitic capacitance, fₛ denotes the switching frequency generated by the oscillator 1, R_{SW} denotes the resistance of a switch S1, S2, S1′, S2′ and Iₒᵤₜ denotes the output current.

Forgetting the parasitic capacitance Cₚₐᵣ and the resistance R_{SW} of the switches, the following simple relation is obtained:

$${V}_{out} = 2 \cdot {V}_{in} - ( \frac{1}{{f}_{s} \cdot C} ) \cdot {I}_{out} . \qquad ( 2 )$$

Equation (2) shows that the output voltage is dependent on four parameters Vᵢₙ, fₛ, C, Iₒᵤₜ.

Vᵢₙ can fluctuate greatly particularly for battery-operated systems. Similarly, fluctuations in the output current Iₒᵤₜ may arise over a certain operating range. In the text below, fluctuations in the parameters C (value of the charge transfer capacitance) and fₛ (switching frequency) are considered. These parameters may vary both as a result of manufacturing tolerances and as a result of changes in temperature.

This means that the dynamic resistance 1/(fₛ·C) of the charge transfer capacitance TC increases when the capacitance value C decreases at constant switching frequency fₛ. Integrated capacitances have a wide range of fluctuation in relation to their absolute value. Consequently, an excessively large capacitance value C may lower the output voltage Vₒᵤₜ to such an extent that the demands made at the load can no longer be met.

In addition, inexpensive oscillators in which the switching frequency is prescribed by a capacitance frequently have a switching frequency fₛ with a significant temperature dependence. This applies particularly to ring oscillators, which are a simple and inexpensive form of implementation for frequency generation in the voltage converter. The oscillator or switching frequency fₛ is dependent on the temperature, the supply voltage and manufacturing parameters.

A ring oscillator comprises a series circuit containing inverters 10, the output of the inverter 10 which is last in the signal path being fed back to the input. A ring oscillator executes a self-starting oscillation having the period 2(2n+1)τ_{d}, where n denotes the number of inverters and τ_{d} denotes the gate transit time of the inverter.

The gate transit time τ_{d} of the inverters and hence also the frequency of the ring oscillator are directly dependent on the value of the capacitance which needs to be charged or discharged upon each inversion. In a conventional ring oscillator which can be used in principle for the invention, this is the gate capacitance of the input FET (Field Effect Transistor) of the next inverter 10. This gate capacitance then needs to be of the same type (e.g. MOSFET) as the charge transfer capacitance TC.

Preferably, the ring oscillator has a capacitance 11 connected to earth at the output of each inverter 10, see FIG. 2. This capacitance 11 is of the same capacitance type as the charge transfer capacitance TC and therefore has the same temperature response as the charge transfer capacitance TC. The result of this is that a reduction in the size of the value C of the charge transfer capacitance TC as a result of fluctuations in the manufacturing process increases the frequency of the ring oscillator on account of the smaller capacitance value C of the capacitances 11. If C assumes a large value as a result of manufacture, the switching frequency fₛ generated by the ring oscillator is reduced. If the capacitance 11 is chosen such that it dominates the total capacitance brought about by the capacitance 11 and the gate capacitance of the subsequent inverter 10, the ring oscillator has a frequency which is inversely proportional to the value of the capacitance 11. In this case, the factor 1/(fₛ·C) in equation (2) remains almost constant under varying manufacturing circumstances. The effect of this is that the dynamic resistance of the charge transfer capacitance TC and hence the output resistance of the charge pump voltage converter likewise remain largely constant i.e. are insensitive towards fluctuations in the manufacturing conditions.

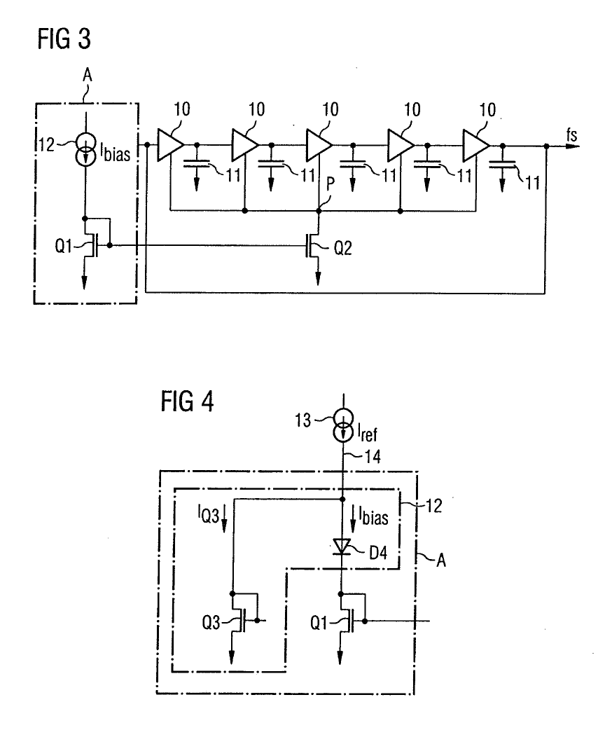

FIG. 3 illustrates a circuit for compensating the temperature dependence of the ring oscillator. The operating current for the ring oscillator is controlled using a current mirror with the transistors Q1 and Q2. The mean operating current of the ring oscillator is in this case directly proportional to a current I_{bias} which flows through the transistor diode Q1 in the first path of the current mirror. In the second path of the current mirror, the operating currents flowing through all of the inverters 10 in the ring oscillator converge at the node P, flow through the transistor Q2 and are controlled and smoothed by the latter.

Controlling the operating current for the ring oscillator allows the frequency of the ring oscillator to be altered. Increasing I_{bias} shortens the gate transit time τ_{d} for each inverter 10, which increases the switching frequency fₛ, and vice versa.

To compensate for the temperature effect, it is necessary to set an operating current which rises as temperature rises (in order to counteract the ring oscillator's frequency reduction brought about as a result of a rise in temperature). The current source 12 shown in FIG. 3 has this characteristic.

FIG. 4 shows a detail A from the circuit shown in FIG. 3 for producing a temperature-compensating operating current for the ring oscillator. An input 14 is used to supply the circuit section A with a temperature-stable reference current I_{ref} which is provided by a reference current source 13. The input 14 of the circuit section A is connected to earth firstly via a diode D4 and the transistor diode Q1 in the first path of the current mirror and secondly via a second transistor diode Q3 which is connected in parallel with the first path of the current mirror. Consequently, the reference current I_{ref} is split into the current I_{bias} and the current I_{Q3} flowing through the transistor diode Q3.

The text below explains the way in which the circuit for producing the operating current for the ring oscillator works. The drain/source current I_{DS} in a MOS transistor follows the relation

$${I}_{DS} = \frac{1}{2} \cdot {μ}_{n} \cdot {C}_{ox} \cdot ( \frac{W}{L} ) \cdot {( {V}_{GS} - {V}_{t} )}^{2} , \qquad ( 3 )$$

where μₙ denotes the mobility of the charge carriers, Cₒₓ denotes the capacitance of the gate oxide per unit area, W denotes the width and L denotes the length of the channel, V_{GS} denotes the gate/source voltage and Vₜ denotes the threshold voltage. At constant gate/source voltage V_{GS}, the drain/source current I_{DS} changes on account of a temperature increase for two reasons:
the mobility μₙ decreases, which reduces the current I_{DS};
the threshold voltage Vₜ decreases, which increases the current I_{DS}.

For MOS transistors with a long channel, the effect brought about by the change in mobility is dominant, since the gate overvoltage is always high and hence insensitive towards fluctuations in Vₜ, whereas for MOS transistors with a short channel length, the effect caused by the change in Vₜ is dominant, since the gate overvoltage is low.

The transistors Q3 and Q1 connected up as diodes are designed such that W₁/L₁>>W₃/L₃ applies. In addition, provision is made for a voltage difference to appear between the gates of the transistors Q1 and Q3 (as explained in more detail later, the voltage difference is brought about by the diode D4). In this case the MOS transistor Q1 operates at a lower gate/source voltage than the transistor Q3. The effect of this is that the ratio of I_{bias} to I_{Q3} is increased when there is an increase in temperature. Consequently, the ring oscillator's operating current flowing through the transistor Q2 increases when there is an increase in temperature.

Preferably, a forward-biased diode D4 is used as voltage source in order to produce the voltage difference between the gates of the MOS transistors Q1 and Q3. The reason for this is two-fold. First, a forward-biased diode produces a voltage of approximately 650 mV, which is practically independent of fluctuations in the manufacturing conditions, while the influence of such fluctuations on the threshold voltage Vₜ of a MOS transistor is very pronounced. When the diode D4 is used, the effects brought about by a change in the threshold voltage Vₜ compensate for one another, however. Changes in the voltage Vₜ which are brought about by manufacturing fluctuations arise in the circuit section A only on the transistors Q3 and Q1. Since the process conditions for manufacturing these transistors are the same, the same fluctuations Vₜ arise in the transistors Q3 and Q1 and compensate for one another. If instead of the diode D4 a MOS transistor were used to produce the voltage difference between the gates of Q3 and Q1, one path of the circuit section A would contain a transistor (Q3) and the other path would contain two transistors (Q1 and the additional transistor). The circuit would be asymmetrical with respect to fluctuations in the threshold voltage Vₜ and would therefore no longer reproduce the desired temperature response with sufficient accuracy for large fluctuations in Vₜ. The second reason for using a diode D4 to produce the voltage difference is that it has a temperature coefficient of approximately −2 mV/K. This means that the voltage difference between the MOS transistors Q1 and Q3 becomes smaller as temperature rises. The effect of this is likewise that a larger current flows through the path D4-Q1 of the circuit section A when there is an increase in temperature.

The most important advantage of the inventive solutions for compensating for the effects brought about by component tolerances and changes in temperature is that it is possible to save chip area, since the large proportioning of the charge transfer capacitance TC required in conventional circuits, which ensures that the demanded tolerance range is observed for the dynamic output resistance of the circuit, is no longer needed on account of the inventive measures.

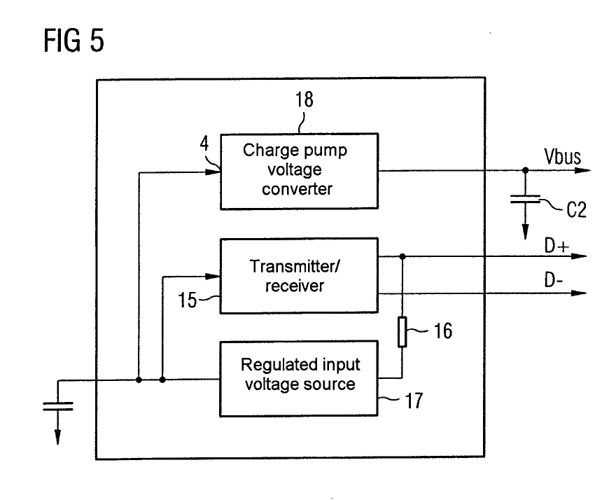

FIG. 5 shows a schematic illustration of a USB interface. The USB interface has two data lines D₊and D₋, in known fashion, which are used to transfer the data transmitted and received by a transmitter/receiver 15. The pull-up resistor 16 prescribed for USB interfaces connects a regulated input voltage source 17 to the data line D₊. The regulated input voltage is also supplied to the transmitter/receiver 15 and to a charge pump voltage converter 18 based on the invention. The output 5 of the inventive charge pump voltage converter 18 provides a voltage V_{bus} which is required by a USB interface (not shown) on a battery-operated appliance (not shown) at the opposite end. As FIG. 5 shows, the charge pump voltage converter 18, the transmitter/receiver 15, the regulated input voltage source 17 and also the pull-up resistor 16 (and further circuits) can be produced on the integrated circuit.

1. A charge pump voltage converter which is produced using integrated circuitry and comprises:
an oscillator for generating a switching frequency, having at least one capacitance whose value governs a switching frequency generated,
a charge transfer capacitance which is charged via an input on the charge pump voltage converter and is discharged via an output on the charge pump voltage converter, and
a switching stage which is operated at the switching frequency and controls the charging and discharging operations of the charge transfer capacitance,
wherein
the charge transfer capacitance and the at least one capacitance in the oscillator are of the same type.

2. The charge pump voltage converter according to claim 1, wherein
the oscillator is a ring oscillator comprising a cascade of inverters.

3. The charge pump voltage converter according to claim 2, wherein
the outputs of the inverters are buffered by the at least one capacitances in the oscillator.

4. The charge pump voltage converter according to claim 3, wherein the at least one capacitances are larger than input capacitances in the inverters.

5. The charge pump voltage converter according to claim 1, comprising a circuit for producing an operating current for the oscillator, which circuit is designed such that the operating current increases as temperature rises, so as thereby to counteract a decrease in the oscillator frequency which occurs as temperature rises.

6. The charge pump voltage converter according to claim 5, wherein the circuit has a first transistor and a current mirror, arranged in parallel with the first transistor, for providing the operating current for the oscillator.

7. The charge pump voltage converter according to claim 6, wherein the input path of the current mirror comprises a second transistor, whose ratio of channel width to channel length is greater than the ratio of channel width to channel length in the first transistor.

8. The charge pump voltage converter according to claim 7, comprising a circuit element which gives rise to an essentially constant voltage difference between the first and the second transistor.

9. The charge pump voltage converter according to claim 8, wherein the circuit element is a diode which is connected in series with the second transistor in the input path of the current mirror.

10. A USB interface having a charge pump voltage converter according to claim 1 for producing the bus operating voltage.

11. A charge pump voltage converter which is produced using integrated circuitry and comprises:
an oscillator for generating a switching frequency which is dependent on a value of at least one capacitance arranged in said oscillator,
a charge transfer capacitance of the same type as the at least one capacitance, wherein the charge transfer capacitance is charged via an input on the charge pump voltage converter and is discharged via an output on the charge pump voltage converter, and
a switching stage which is operated at the switching frequency and controls the charging and discharging operations of the charge transfer capacitance.

12. The charge pump voltage converter according to claim 11, wherein
the oscillator is a ring oscillator comprising a cascade of inverters.

13. The charge pump voltage converter according to claim 12, wherein
the outputs of the inverters are buffered by the at least one capacitances in the oscillator.

14. The charge pump voltage converter according to claim 13, wherein the at least one capacitances are larger than input capacitances in the inverters.

15. The charge pump voltage converter according to claim 1, comprising a circuit for producing an operating current for the oscillator, which circuit is designed such that the operating current increases as temperature rises, so as thereby to counteract a decrease in the oscillator frequency which occurs as temperature rises.

16. The charge pump voltage converter according to claim 15, wherein the circuit has a first transistor and a current mirror, arranged in parallel with the first transistor, for providing the operating current for the oscillator.

17. The charge pump voltage converter according to claim 16, wherein the input path of the current mirror comprises a second transistor, whose ratio of channel width to channel length is greater than the ratio of channel width to channel length in the first transistor.

18. The charge pump voltage converter according to claim 17, comprising a circuit element which gives rise to an essentially constant voltage difference between the first and the second transistor.

19. The charge pump voltage converter according to claim 18, wherein the circuit element is a diode which is connected in series with the second transistor in the input path of the current mirror.

20. A USB interface having a charge pump voltage converter according to claim 11 for producing the bus operating voltage.
